(19) United States
(12) Patent Application Publication
(10) Pub. No.: US 2009/0030822 A1
(43) Pub. Date: Jan. 29, 2009

(54) System and Method for Contingent Equity Return Forward to Hedge Foreign Exchange Risk in Investments Having Varying Exit Parameters

(75) Inventor: Mark G. Cresswell, London (GB)

Correspondence Address: GOODWIN PROCTER LLP, 901 NEW YORK AVENUE, N.W., WASHINGTON, DC, 20001, US

(73) Assignee: JPMorgan Chase Bank, N.A.

(21) Appl. No.: 11/950,851

(22) Filed: Dec. 5, 2007

Related U.S. Application Data
(60) Provisional application No. 60/894,399, filed on Mar. 12, 2007.

(51) Int. Cl. G06Q 40/00

(52) U.S. Cl. 705/35

(57) ABSTRACT

According to one embodiment, the invention comprises a system and method for hedging an investment. In various embodiments, a risk parameter associated with the investment is identified. According to some aspects of invention, the risk parameter may correspond to Foreign Exchange risk. A notional value of the underlying investment is determined or otherwise calculated. Then one or more maturity events are determined or otherwise constructed. The notional value and the maturity events can be used to create or otherwise issue an investment hedge for the risk parameter. Upon the occurrence of one of the pre-determined maturity events, the investment hedge's notional value is adjusted. A premium may also calculated for the investment hedge in various embodiments.

### RELATED APPLICATIONS

This application asserts priority under 35 U.S.C. § 119(e) to U.S. Provisional Patent Application No. 60/894,399 under docket number 72167.000623, entitled “System and Method for Contingent Equity Return Forward to Hedge Foreign Exchange Risk in Investments Having Varying Exit Parameters,” filed Mar. 12, 2007, which is hereby incorporated by reference in its entirety.

### FIELD OF THE INVENTION

The present invention relates generally to systems and methods for hedging investment risk, and more particularly, to a system and method for hedging the foreign exchange risk associated with the exit from an investment made in one currency for an investment fund operating in a different currency.

### BACKGROUND OF THE INVENTION

Private investment funds span a range of investment funds that are commonly described by a variety of terms including Hedge Funds, Venture Capital Funds, Buyout Funds, Leveraged Buyout Funds and Financial Sponsors. They are an asset class offering an alternative to conventional capital market investments (e.g. public and government bonds, equity capital markets). Such Private investment funds typically raise their investment capital from investors that include limited partnerships, insurance companies, endowments, and other well-capitalized investors or investment entities. Hereinafter, a private investment fund, however structured, is referred to as a Financial Sponsor (FS).

Financial Sponsors typically seek to make investments in assets having risk profiles and/or return potentials that are not available directly from public equity markets, public bond markets, and the like. For example, some FS Funds may seek investment returns by acquiring controlling interests in companies or by investing in start-up companies. Often FS Funds will make investments by purchasing stakes in private companies or by acquiring companies outright. FS Funds may be particularly interested in investing in assets that are decoupled from (or at least not well correlated with) the performance of the public capital markets. In this manner, investors in FS Funds are seeking more diversified investment portfolios than would be available from investing in the capital markets alone.

FS Funds usually raise money from third party investors in a single currency, and subsequently measure their returns in that same currency. For example, a Sterling denominated FS Fund will typically measure investment returns in Sterling (£). However, such FS Funds do not want to be limited to investing in assets denominated in the currency of the fund. Commercially, they require the ability to invest in assets they perceive as offering an attractive return without being constrained by the currency in which the investment is made. Hereinafter, an asset denominated in a currency other than the currency of an FS Fund's investment capital is referred to as a Foreign Currency Asset, and such investments as Foreign Currency Investments.

For example, the illustrative Blackrock Ltd. is a Sterling denominated FS Fund. Blackrock Ltd. will not wish to be confined to Sterling denominated investments. The Fund will require the ability to purchase attractive assets in the United States, denominated in U.S. Dollars, in order to maximize its investment returns.

This flexibility in making investments necessitates accessing the Foreign Exchange market. To purchase a Foreign Currency Asset, the FS Fund will first purchase cash in the foreign currency in which the asset is denominated. This purchase will be made using capital from the fund. Having acquired cash denominated in the foreign currency of the asset, the Foreign Currency Asset may then be purchased.

For example, Blackrock Ltd. seeks to purchase a Foreign Currency Asset in the United States for which the agreed price is US$200 million. At the time of the purchase, the Foreign Exchange Rate is 2.00 US$/GB£. Blackrock Ltd. uses the Foreign Exchange market to purchase $200 million dollars with £100 million of its Sterling investment capital. Blackrock Ltd. then uses those $200 million to purchase the Foreign Currency Asset.

At the time of the Initial Investment the Foreign Exchange Rate is known or subject to only small fluctuations (within the timeframe of agreeing the price and purchasing the Foreign Currency Asset). Where these risks are currently managed, FS Funds currently use Foreign Exchange contracts including FX forwards, FX options, deal contingent forwards, and credit contingent knock-out forwards and other structures that will be apparent to the person of ordinary skill in the art.

FS Funds typically hold a particular investment for a number of years before selling the asset and crystallizing the financial return on the investment. The financial return achieved for the fund is measured in the currency of the fund, at the time of disposal. In the case of any Foreign Currency Asset, the financial return depends upon three different variables:

The Final Sale Price of the asset—being the sale price achieved for the Foreign Currency Asset upon sale. This amount will tend to be denominated in the same Foreign Currency as the Initial Investment, and requires exchanging back into the currency of the FS Fund.

The Final Exchange Rate—being the Foreign Exchange Rate at which the sale proceeds are used to purchase cash in the currency of the FS Fund.

The Disposal Date—being the date on which investment capital is returned to the FS Fund. (Funds will be concerned to maximize their annual returns).

When the Initial Investment takes place, none of these variables is known. They will each depend upon a variety of business and financial factors including the performance of the Foreign Currency Asset during the timeframe of the investment, related corporate activity in the sector of the investment (e.g., the purchase of other related businesses), the cost and availability of capital in the market (i.e., availability of capital for any future acquirer of the asset), and other unknowns.

However, each of these three variables can have a profound effect on the financial return achieved by the FS Fund on the Foreign Asset Investment.

For example, the illustrative Blackrock Ltd. seeks to sell the Foreign Currency Asset for which it paid $200 million using £100 million of investment capital. A sale is expected on the third anniversary of the purchase. The Final Sale Price is expected to be $300 million. The Exchange Rate in the market at the time is 2.00 US$/GBP. The $300 million sale proceeds could be used to purchase £150 million. A 50% Sterling return over 3 years, equivalent to a 14.5% compound annual return. Suppose now the sale is delayed by six months. The Disposal Date occurs 42 months after the Initial Investment. The Final Sale Price rises to $325 million however, foreign exchange rates have risen during the intervening six months to 2.25 US$/GBP. The $325 million Final Sale Price can now only purchase £144 million. Blackrock Ltd. achieves a 44% return over three and a half years, equivalent to a 11.1% compound annual return. This example highlights the risk that, despite asset prices rising, weakening Exchange Rates and delayed disposal can act to reduce financial returns of the fund.

It will be apparent to the person of ordinary skill in the art that FS Funds will wish to manage the Foreign Exchange risk that derives from investing in Foreign Currency Assets. It will further be apparent that the Foreign Exchange risk associated with such investments derives from all three of the above variables.

Any system or method for hedging this Foreign Exchange risk will need to consider three corresponding components of risk, these being:

Notional Risk—The uncertainty surrounding the Final Sale Price introduces uncertainty into the notional amount of Foreign Currency that will be exchanged. Suppose, in the above example, Blackrock Ltd. anticipated a Final Sale Price of $250 million and hedged that notional amount. In the event the Final Sale Price is $325 million, the hedge notional is insufficient and Blackrock Ltd. is unprotected against currency weakening on $75 million of proceeds. In the event the Final Sale Price were less than $250 million, then Blackrock's hedge notional is too large, resulting in either increased costs, or additional currency risk.

Exchange Rate Risk—The uncertainty surrounding the Final Exchange Rate introduces uncertainty into rate at which Foreign Currency is Exchanged. Blackrock Ltd. may wish to protect against a weakening in the US Dollar during the life of the Foreign Asset Investment by guaranteeing a rate in the future through a hedging system or mechanism.

Maturity Risk—The uncertainty around the Disposal Date introduces uncertainty as to the timing of the final currency exchange. Suppose, in the above example, Blackrock Ltd. anticipated a Disposal Date three years after purchasing the Foreign Currency Asset. Blackrock implements a fixed maturity hedge alongside the Initial Investment protecting against currency weakening up until the third anniversary of the purchase. Were the sale to be delayed to 6 months, Blackrock would be unprotected against any currency changes after that three year maturity.

In the past, investors have sought to hedge against FX investment risk using several approaches. These have focused on Exchange Rate Risk without fully addressing Notional Risk or Maturity Risk.

One approach is to enter into an FX forward structure which provides for payment of some notional (principal) amount at an agreed-upon price (FX rate) at a predetermined date in the future (term). Such a structure has a fixed notional and a fixed maturity, thereby failing to fully address Notional Risk or Maturity Risk.

Such an FX forward also has a profound deficiency in that there is a “double downside” risk. In our illustration, Blackrock invested £100 million to purchase a Foreign Currency Asset for $200 million. Suppose the company entered into a FX Forward contract struck at 2.00US$/GBP to purchase £125 million with $250 million maturing on the third anniversary of the Initial Investment. Suppose the sale was delayed, and at maturity of the contract, the prevailing FX rate was 1.75 US$/GBP. Blackrock would owe $31 million to their counterparty ($250 million minus £125 million×1.75 US$/GBP). They would be left without a hedge, and owing cash at a time when they have none because they have not yet sold the Foreign Currency Asset.

Another approach to hedging FX investment risk associated with Foreign Currency Assets is to purchase an FX option. An FX option is a contract providing the right, but not the obligation, to purchase (call) a destination currency (e.g., English pounds, £) using a start currency (e.g., U.S. dollars, $) at a specified exchange rate (strike price) up until a specific maturity date (term). Once again, such a structure has a fixed notional and a fixed maturity, thereby failing to fully address Notional Risk or Maturity Risk.

Such FX options require an upfront payment by the FS Fund. The risk remains that the maturity of the option will occur before the disposal of the Foreign Currency Asset. In that case, the premium paid for the option may be lost, and the FS Fund will have unprotected FX risk for the remainder of the investment. On the other hand, if the investor exits the investment well before the end of the option term, then the investor paid a higher premium than necessary on the original FX option hedge. A payment it may not recover.

A deal contingent forward is a contract which provides for payment of some notional amount at an agreed-upon price (FX exchange rate) at a predetermined date in the future (term). The contract is only enforceable if the investment in the Foreign Currency Asset to which it refers takes place. (If the asset is purchased, the forward provides a guaranteed exchange rate; if the asset is not purchased, the forward obligation disappears). These structures help protect against short-term FX risk that surrounds purchasing Foreign Currency Assets. They are not appropriate for medium to long-term risk associated with disposal of assets.

A credit-contingent ‘knock-out’ hedge is a structure in which an FS Fund executes an Exchange Rate hedge for the underlying investment that references a bond issued by the Foreign Exchange Asset. In the event that the bond defaults, the hedge ‘knocks out’. In that instance, the contract is voided, and no further obligation exists under the contract. The expectation is that, in the event the bond defaults, there will be no disposal proceeds requiring an Exchange Rate hedge.

It will be apparent that such structures have a fixed maturity and a fixed notional except in the occurrence of the ‘knock-out’ event. As such, they fail to fully address Notional Risk or Maturity Risk inherent in Foreign Currency Investments.

It should be readily apparent to those skilled in the art that the above structures and others of their kind do not satisfactorily address Notional Risk or Maturity Risk, leaving FS Funds exposed to Foreign Exchange risks on Foreign Currency Assets, potentially preventing them from investing in otherwise attractive investments.

More broadly, no investment hedge system currently exists in which an FS Fund can effectively and efficiently hedge against the future FX risk inherent in Foreign Currency Assets with an unknown exit timeframe and an unknown return on the investment.

Other problems and drawbacks also exist.

### SUMMARY OF THE INVENTION

According to one embodiment, the invention comprises a system and method for hedging an investment. A notional value of the underlying investment is determined or otherwise calculated. Then one or more maturity events are determined or otherwise constructed. The notional value and the maturity events are used to create or otherwise issue an investment hedge. Upon the occurrence of one of the pre-determined maturity events, the investment hedge's notional value is adjusted. A premium is also calculated for the investment hedge.

It should be readily apparent to those skilled in the art that this pre-defined flexibility in the maturity and notional value of the hedge acts to address the Maturity Risk and Notional Risk previously outlined.

According to various aspects of the invention, the maturity events may be any disposal of the investment, a partial sale of the investment, a credit event at the investment, or any other whole or partial exit from the investment, or corporate action carried out by the Foreign Currency Asset or its Legal Group. In another of the various aspects, this may include dividends paid out of the Foreign Currency Investment to the FS Fund, or any other dividends or equity entitlements paid by the investment.

According to another aspect of the invention, a return on the investment may be determined or otherwise calculated. This return may then be utilized when adjusting the notional value upon a maturity event. In another of the various aspects, the adjusted notional value may not exceed a pre-determined amount.

According to another aspect of the invention, a premium rate may be determined or otherwise calculated. This premium rate may be utilized in combination with the adjusted notional value in order to calculate the premium for the investment hedge. The premium rate may also be utilized in combination with the return on the investment in order to calculate the premium for the investment hedge.

According to other aspects of the invention, the investment hedge can be split upon certain Maturity Events. In certain circumstances, a portion of the hedge would remain to reduce the Foreign Exchange risk inherent in the remaining portion of the investment. A premium would be calculated and settled together with the execution of a hedge on the capital released from the investment.

According to other aspects of the invention, the investment hedge can reach a maximum term, at which date the hedge system or method may calculate a mark-to-market value of the hedge with reference to market conditions at that time. Upon the subsequent sale or liquidation of the underlying investment, a premium may then be calculated based, in part, on the prior mark-to-market calculation.

According to another embodiment, the invention comprises a system and method for hedging the foreign exchange risk of an investment. A Financial Sponsor may reside in one currency market, while the investment resides in another currency market. An exchange rate which fluctuates may exist between the two currency markets. In order to hedge the exchange risk inherent in the foreign investment, the Financial Sponsor enters into an exchange rate investment hedge. The hedge determines a notional value, a set of maturity events, and a premium rate under which it operates. When one of the maturity events occurs, the hedge adjusts the notional value downward if the return on the investment is less than the original investment. After any adjustments, the hedge calculates and changes a premium value based on the return on the investment and the predetermined premium rate.

The present invention, which in some instances may be referred to as the “Contingent Equity Return Forward,” or “CERF” product, has numerous benefits and advantages. The invention provides an efficient and effective way to hedge against the foreign exchange risk inherent in Foreign Currency Assets using a variable-notional which is calculated at potentially variable-maturities.

The variable-notional of the investment hedge is advantageous to an FS Fund because it allows the FS Fund to hedge with greater certainty the amount of investment proceeds arising from a Foreign Currency Investment without knowledge of the investment's performance at the outset of the investment. This enables the FS Fund to avoid purchasing an over-sized or overly expensive nominal hedge in order to hedge the return on the Foreign Asset Investment, or from experiencing the situation when a foreign investment has a negative return on the investment yet the FS Fund is still required to settle the full value of the original hedge.

Further, the variable-maturity of the investment hedge is advantageous to an FS Fund because it allows the FS Fund to hedge with greater certainty the term of the Foreign Asset Investment without knowledge of the investment's duration at the outset of the investment. This enables the FS Fund to avoid purchasing an over-long or overly expensive hedge and reduces the likelihood that any Foreign Exchange hedge matures prior to the disposal of the asset thereby leaving residual unprotected risk.

Because the invention allows investors in foreign entities to more effectively hedge the FX exposure of their investment portfolios, FS Firms utilizing the invention will be positioned to invest their capital in Foreign Currency Assets as they come available at greatly reduced risk

Other benefits and advantages of the invention will be apparent to the person of ordinary skill in the art.

Accordingly, it is one object of the present invention to overcome one or more of the aforementioned and other limitations of existing systems and methods for hedging FX risk inherent in the investment of foreign entities.

It is another object of the invention to provide a system and method for providing an investment hedge that is notional-variable.

It is another object of the invention to provide a system and method for providing an investment hedge that is term-variable.

It is another object of the invention to provide a system and method for providing an investment hedge that can be split as segments of the underlying investment are sold or otherwise divested.

It is another object of the invention to provide a system and method for providing an investment hedge that includes different hedging structures, such as forwards, options, collars, and so forth.

The accompanying drawings are included to provide a further understanding of the invention and are incorporated in and constitute part of this specification, illustrate several embodiments of the invention and, together with the description, serve to explain the principles of the invention. It will become apparent from the drawings and detailed description that other objects, advantages and benefits of the invention also exist.

Additional features and advantages of the invention will be set forth in the description that follows, including the figures, and in part will be apparent from the description, or may be learned by practice of the invention. The objectives and other advantages of the invention will be realized and attained by the system and methods, particularly pointed out in the written description and claims hereof as well as the appended drawings.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is a block diagram illustrating an operating environment for an investment hedge system in accordance with an embodiment of the invention.

FIG. 2 is a block diagram illustrating an investment hedge system in accordance with an embodiment of the invention.

FIG. 3 is a flow chart illustrating a method of execution of an investment hedge system in accordance with an embodiment of the invention.

FIGS. 4a, 4b, and 4c are charts illustrating various implementations of hedge structures in accordance with various aspects of the invention.

FIGS. 5a and 5b are flow charts illustrating various adjustments of the notional value in accordance with various aspects of the invention.

FIGS. 6a and 6b are charts illustrating various implementations of premiums and nationals in accordance with various aspects of the invention.

### DETAILED DESCRIPTION OF THE INVENTION

Embodiments of the present invention are directed to an investment hedge system and method that allows for an adjustable notional value of the investment hedge that matures at a variable term.

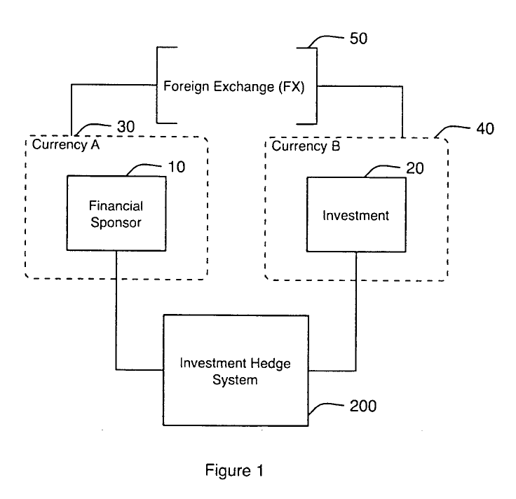

FIG. 1 is a block diagram illustrating an operating environment for an investment hedge system in accordance with an embodiment of the invention. An investment hedge system 200 operates between a Financial Sponsor 10 and an investment 20. The Financial Sponsor 20 may desire to purchase a portion or an entirety of the investment 20 with the hope that it will appreciate in value over time. According to various aspects of the invention, the investment 20 could be a business entity such as a corporation or a partnership, a financial security, a derivative, a real estate property, an intellectual property right or license, or other tangible or intangible assets. Typically, investments such as investment 20 have risks associated with their purchase and subsequent sale. These risks may be accounted for by the investor such as Financial Sponsor 10. Financial sponsor 10 may even specialize in the purchase of investments of the kind of investment 20, making Financial Sponsor 10 an expert in that kind of investment. Consequently Financial Sponsor 10 may be able to better analyze and compute any of these risks associated with investment 20.

In one aspect of the invention as illustrated in FIG. 1, the Financial Sponsor 10 may be located in a jurisdiction with currency A 30 and the investment 20 may be located in a jurisdiction with currency B 40. These two currencies may then have a foreign exchange (FX) rate 50. Typically, FX rates are not stable and may fluctuate continuously between two jurisdictions. As a result, this fluctuation can bring additional risk to the investment 20 for the Financial Sponsor 10. In contrast to the kind of investment risk mentioned above, the Financial Sponsor 10 may not be well versed in this FX rate risk. As will be further explained below, the investment hedge system 200 allows the Financial Sponsor 10 to effectively and efficiently hedge against FX risk associated with the investment 20.

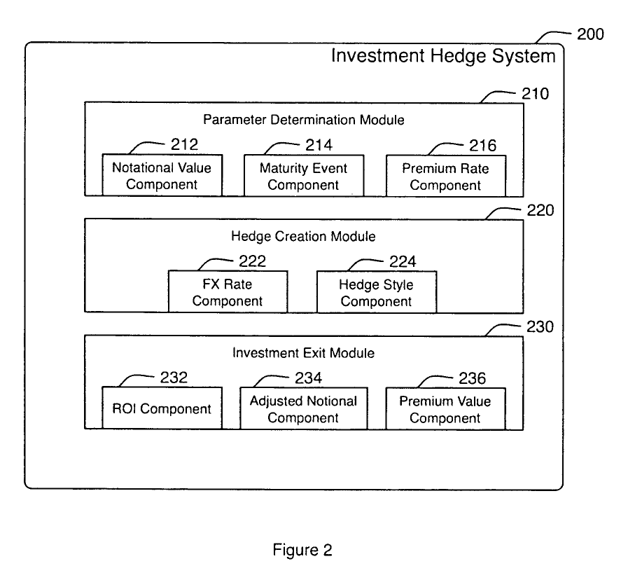

FIG. 2 is a block diagram illustrating an investment hedge system 200 in accordance with an embodiment of the invention. The investment hedge system 200 may include instructions executed on a computer.

The investment hedge system 200 as shown in FIG. 2 may be or include a computer system. The investment hedge system 200 may be described in the general context of computer-executable instructions, such as program modules, being executed by a computer. Generally, program modules include routines, programs, objects, components, data structures, etc. that perform particular tasks.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (1310S), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system or platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The investment hedge system 200 may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths. For some aspects of the invention, such as for the transfer of payments, the communications infrastructure may include networked systems such as the Electronic Funds Transfer (EFT) network, trade exchanges, and other communication channels known in the industry for implementing trading transactions (which may include settlement operations) such that those described herein.

Although many other internal components of the computer are not shown, those of ordinary skill in the art will appreciate that such components and the interconnections are well known. Accordingly, additional details concerning the internal construction of the computer need not be disclosed in connection with the present invention.

As illustrated in FIG. 2, the investment hedge system 200 of an embodiment of the invention may include a parameter determination module 210, a hedge creation module 220, and an investment exit module 230. The parameter determination module 210 may include components that execute instructions in a computerized environment as described above. A notional value component 212 may determine an appropriate initial notional value for the investment hedge. A maturity event component 214 may determine various maturity events that are appropriate for the Financial Sponsor and the underlying investment. A premium rate component 216 may determine a premium rate for the investment hedge that can later be used, as will be described in more detail below, to compute a premium value for the investment hedge. The hedge creation module 220 and investment exit module 230 may also include components that execute instructions in a computerized environment. The hedge creation module 220 may include an FX rate component 222 that may determine an agreed upon exchange rate for the investment hedge, and a hedge style component 224 that may determine the style of hedge to be utilized in the investment hedge. Together, these components may assist the hedge creation module 220 in creating an investment hedge for the Financial Sponsor, which may be linked to and may cover the investment, by processing the outputs of the parameter determination module 210 along with any additional information which may be considered pertinent to the creation of the investment hedge, such as information supplied by the Financial Sponsor, information concerning the investment, or any other public or private information, as will be appreciated by one of ordinary skill and more fully described below. The investment exit module 230 may include a ROI component 232 that may determine the ROI of an underlying investment, an adjusted notional component 234 that may adjust the notional value based on the ROI of the underlying investment, and a premium value component 236 that may determine or calculate a premium value on the investment hedge. Together, these components may assist the investment exit module 230 in settling or executing the investment hedge, as will also be described in more detail below.

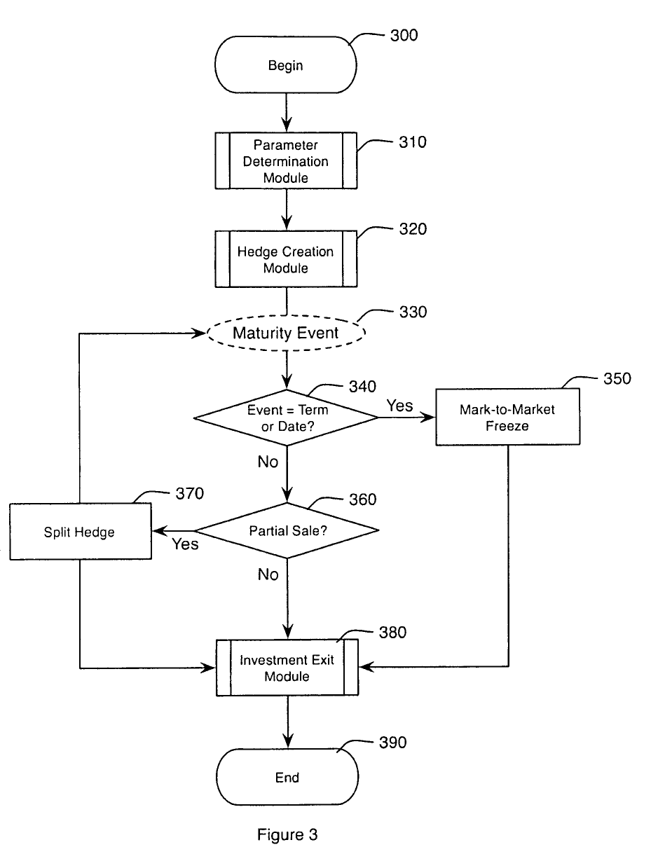

FIG. 3 is a flow chart illustrating a method of execution of an investment hedge system in accordance with an embodiment of the invention. Following the start of the method at 300, the parameter determination module is executed at 310. At this step, the parameter determination module may determine the values for the notional value component 212, the maturity event component 214, and the premium rate component 216. For the determination of components 212-216 according to one embodiment of the invention, the parameter determination module gathers input data concerning the Financial Sponsor and the investment. This information may be gathered from publicly available data sources such as the internet; publicly available records, such as land, business, government, or court records; private databases or data services, such as Hoovers™, Standard & Poor's™, or Dow Jones™; private investment banks, such as JPMorgan Chase™ or PiperJaffray™; private investigation firms; the Financial Sponsor; or the investment itself.

With this input data, the notional value component 212 may determine a notional value at which the investment hedge may be based. According to one aspect of the invention, this notional value may be equal to the initial equity investment made by Financial Sponsor in investment. Also according to one aspect of the invention, the input data used by the notional value component 212 in determining the notional value for the investment hedge may be provided by the Financial Sponsor as a selection of the amount of capital the Financial Sponsor wishes to hedge. As can be appreciated by one of ordinary skill, and in accordance with other various embodiments of the invention, this notional value may be any amount greater or lesser than the initial equity investment in investment, such as 25%, 50%, 75%, 125%, 150%, 175%, or 200% of this initial investment outlay. According to another embodiment of the invention, the investment may already be purchased by Financial Sponsor. According to an optional aspect of this embodiment, the Financial Sponsor may wish to enter into the investment hedge after a significant term of years after the initial purchase of the investment. In this instance, the notional value component 212 determines an “initial notional” which may be based upon a best estimate of the residual value of the investment once any outstanding debt has been taken into account.

Also with this input data, the maturity event component 214 may determine a set of maturity events at which the investment hedge may mature. According to one aspect of the invention, the set of maturity events can include a disposal of the investment, a partial sale or divestment of the investment, a credit event at the investment, a financial restructuring or recapitalization of the investment, any conversion or absorption of the investment into the Financial Sponsor, an occurrence of a maturity date, an expiration of a maturity term, a financial collapse of the investment, a default of the investment, a bankruptcy of the investment, a financial collapse of the Financial Sponsor, a default of the Financial Sponsor, a bankruptcy of the Financial Sponsor, a merger of the investment with another corporate entity, a sale or partial sale of subsidiaries of the investment's legal group, a payment of extraordinary dividends or similar distributions by the investment to the Financial Sponsor or its partners, any other release of capital from the investment, any other market event, or any other event which would register as a partial or complete exit of the investment by the Financial Sponsor. According to one embodiment of the invention, the maturity term may be equal to five years. According to another aspect of the invention, the set of maturity events can be limited to a single event, such as a complete or partial exit from the investment, as detailed above, or a completion of a term of years, months, or days. In one embodiment of the invention, this set of maturity events may be selected by the Financial Sponsor from a listing of optional events. In another embodiment of the invention, the Financial Sponsor may propose its own maturity events for inclusion in the set of maturity events. In yet another embodiment of the invention, the maturity event component 214 may determine the set of maturity events based upon the markets in which the Financial Sponsor and the investment operate, such as any political, economic, social, environmental, seasonal, regional, or other risks; any perceived strength, financial, institutional, historical, political, or otherwise, of the Financial Sponsor or the investment; the amount of capital involved in the investment; the amount of notional value calculated; or any other factors which can be appreciated by one of ordinary skill to be pertinent to such a system.

Additionally, this input data may be utilized by the premium rate component 216 in determining the premium rate for the investment hedge, which may later be utilized in calculating a premium value for the investment hedge. This premium value may be the cost at which an issuer may be willing to accept for the issuance of such an investment hedge to the Financial Sponsor. Such an issuer may be a financial services group or other investment banking entity as will be appreciated by those of ordinary skill According to one aspect of the invention, this rate may be determined by analyzing the determined notional value and the determined maturity events, as they relate to the Financial Sponsor and the investment, and further as they relate to any of the markets in which the Financial Sponsor and the investment operate, such as any political, economic, social, environmental, seasonal, regional, or other risks; any perceived strength, financial, institutional, historical, political, or otherwise, of the Financial Sponsor or the investment; the amount of capital involved in the investment; or any other factors which can be appreciated by one of ordinary skill to be pertinent to such a system. According to another aspect of the invention, the premium rate may be determined in concert with the notional value and the set of maturity events. In such an aspect, the Financial Sponsor may be presented with a series of selections for notional values and maturity events, along with corresponding information regarding the affect those selections have upon such a premium rate. In an alternative exemplary aspect, the Financial Sponsor may set a target premium rate or premium rate range which would then affect the selections available to the Financial Sponsor with regard to notional values and maturity events. In yet another embodiment of the invention, the premium rate may be solely calculated and determined by the issuer of the investment hedge system itself. In a further embodiment, a combination of the Financial Sponsor's inputs and the investment hedge's calculations and determinations may be used.

At 320, the hedge creation module creates the investment hedge using the determinations from the parameter determination module. According to one embodiment of the invention, the hedge creation module creates an FX investment hedge structure for the Financial Sponsor which is based upon the investment. This structure may contain the previously determined notional value, set of maturity events, and premium rate. Further, this structure may contain additional parameters, which may include an agreed upon exchange rate at which the FX investment hedge will be valid. In one aspect of the invention, this exchange rate may be the rate at which currency of the Financial Sponsor and the currency of the investment trades at the time of the creation of the FX investment hedge. In another aspect of the invention, the FX investment hedge exchange rate may be higher or lower than the actual exchange rate at the time of creation. This may be due to a variety of factors, which may include expected fluctuations and changes in foreign exchange markets, desires of the Financial Sponsor, or desires of the issuer of the investment hedge. Additionally, in another embodiment of the invention, the agreed FX investment hedge exchange rate may be utilized by the previously described parameter determination module in the calculation of a premium rate, notional value, or any maturity events. It can be appreciated by one of ordinary skill in the art that other embodiments exist wherein the various components described above can be combined and reordered in a multitude of variations in order to create the investment hedge.

According to another aspect of the invention, the hedge creation module creates an investment hedge which may additionally include a selection of the style of hedge desired. In this aspect, the investment hedge could include a selection of a “Contingent Equity Return Forward,” a “Contingent Equity Return Option,” a “Contingent Equity Return Collar,” a “Contingent Equity Return Capped Risk Forward,” or other styles of investment hedges which will be appreciated and apparent to one of ordinary skill. Additionally, in another embodiment of the invention, the style of hedge selected may be utilized by the previously described parameter determination module in the calculation of a premium rate, notional value, or any maturity events.

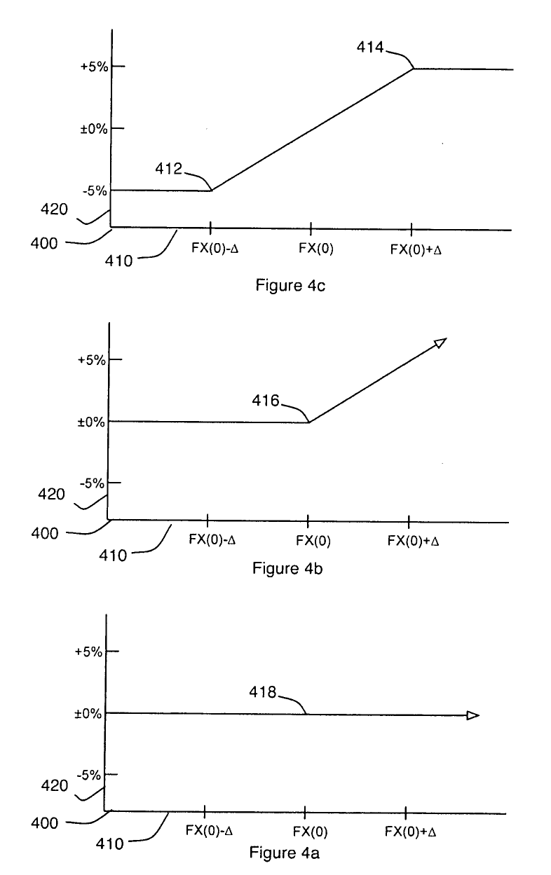

In a “Contingent Equity Return Forward,” or “CERF,” style of hedge, an agreed upon exchange rate, as described above, may be determined and, upon the completion of the hedge, the hedge operates as to convert the equity invested in the investment in currency B into currency A at the agreed upon exchange rate irrespective of the foreign exchange rate in effect at the time of the conversion. FIG. 4a is illustrative of how the CERF style of hedge is applied with varying exchange rates. Chart axis 400 shows a comparison of the various possible foreign exchange rates at the time of divestment or sale of the investment, as it varies along axis 410 with reference to the exchange rate at the time of creation of the investment hedge (FX(0)), against the gain or loss experienced by the Financial Sponsor that is attributable to exchange rate risk along axis 420. Line 418 shows that a CREF style of hedge maintains a constant level of zero exposure for the hedged amount regardless of any fluctuations in the exchange rate.

In a “Contingent Equity Return Option,” or “CERO,” style of hedge, an agreed upon exchange rate may be determined in a similar manner as described above. In a CERO style hedge, the agreed upon rate may not be binding upon the Financial Sponsor. In other words, at the completion of the investment hedge, the agreed upon exchange rate in a CERO style investment hedge may only be implemented by the Financial Sponsor when the foreign exchange rate in effect at the time of completion is less favorable to the Financial Sponsor than the agreed upon exchange rate. When the foreign exchange rate in effect at the time of completion is more favorable than the agreed upon exchange rate, the Financial Sponsor is free to take advantage of the market foreign exchange rate. FIG. 4b is illustrative of how the CERO style of hedge is applied with varying exchange rates. Chart axis 400 shows a comparison of the various possible foreign exchange rates at the time of divestment or sale of the investment, as it varies along axis 410 with reference to the exchange rate at the time of creation of the investment hedge (FX(0)), against the gain or loss experienced by the Financial Sponsor that is attributable to exchange rate risk along axis 420. The line to the left of point 416 shows zero exchange rate risk exposure as the CERO is exercised by the Financial Sponsor when exchange rates fall below the agreed upon rate. The upward sloped line to the right of point 416 shows infinite exchange rate gain when exchange rates increase after the formation of the investment hedge as the CERO is left unexercised by the Financial Sponsor in this instance.

In a “Contingent Equity Return Collar,” or “CERC,” style of hedge, two agreed upon exchange rates may be determined. These two agreed upon exchange rates may constitute an upper limit rate and a lower limit rate. The magnitude of this range may vary depending upon the previously input data in the system, the determined notional value, the determined set of maturity events, the determined premium rate, the desires of the Financial Sponsor, or the desires of an issuer of the investment hedge. In contrast with the CERO style hedge, the agreed upon exchange rates of a CERC hedge may be binding upon either the hedge provider or the Financial Sponsor when the foreign exchange rate in effect at the time of completion of the investment hedge is outside the range created by the upper limit rate and the lower limit rate. Consequently, this style of hedge allows the Financial Sponsor the freedom to take-on limited exchange risk exposure without being fully exposed to the foreign exchange markets. FIG. 4c is illustrative of how the CERC style of hedge is applied with varying exchange rates. Chart axis 400 shows a comparison of the various possible foreign exchange rates at the time of divestment or sale of the investment, as it varies along axis 410 with reference to the exchange rate at the time of creation of the investment hedge (FX(0)), against the gain or loss experienced by the Financial Sponsor that is attributable to exchange rate risk along axis 420. Points 412 and 414 show the lower and upper limit rates of the CERC style of hedge, respectively. The line to the left of point 412 shows the exchange rate risk exposure as the CERC is exercised by the Financial Sponsor when exchange rates fall below the acceptable level of risk as determined at the creation of the investment hedge. The line to the right of point 414 shows the capped exchange rate gain realized by the Financial Sponsor as the issuer of the investment hedge exercises the upper limit rate. The line between points 412 and 414 shows the entirety of limited exchange rate risk exposure the Financial Sponsor will have to endure under the CERC style of hedge.

In a “Contingent Equity Return Capped Risk Forward,” or “CERCRF,” style of hedge, a Forward FX rate is agreed at inception of the hedge. As a modification to the CERF hedge, upon a Maturity Event taking place, the Financial Sponsor may not be contractually bound to exchange funds at the Forward FX rate depending upon the prevailing market conditions. If the Exchange Rate then prevailing in the market is more favourable to the Financial Sponsor than the Forward FX rate, the hedge falls away (enabling the Financial Sponsor to benefit from this preferable market rate). However, if the Exchange Rate available at that time in the market is less advantageous than the Forward FX rate within the CERCRF, the Financial Sponsor will enforce the hedge. (The notional of the hedge upon a Maturity event could be determined in all of the ways outlined previously).

For example, suppose a Financial Sponsor enters into a Contingent Equity Return Capped Risk Forward to sell US Dollars and purchase British Sterling at a Forward FX rate of 1.46. Suppose, upon a Maturity Event, the prevailing Exchange rate available in the market were 1.40. The hedge would fall away and the Financial Sponsor would be able to purchase British Sterling at the more advantageous rate of 1.40. Were the prevailing rate to have risen to 1.50, the hedge would remain in force, and the financial sponsor would benefit from the preferable Forward FX rate of 1.46 under the terms of the hedge. In this way, the Financial Sponsor's risk is capped at the Forward FX rate.

In various other embodiments, the disclosed investment hedge structures may be utilized to reduce risks beyond FX rate risk. Some of these other risks may include interest rate risk, credit risk, commodity price risk, price risk associated with weather futures, property derivatives risk, and longevity risk. It can be appreciated by those of ordinary skill in the art that other types of risk may be mitigated by the various embodiments of investment hedge structures disclosed.

At 330, one of the set of maturity events occurs, which may trigger the execution of steps 340-390. According to one embodiment of the invention, the first occurrence of any of the set of maturity events can trigger the continuation of the steps in the method. According to another embodiment, certain maturity events in the set of maturity events would have to occur a first time before any other maturity events in the set of maturity events could trigger the subsequent steps. One of these instances could be the passage of a specific date or the tolling of a minimum term of years, months, or days. Another of these instances could be a threshold credit or capital event.

At 340, the investment hedge system may optionally determine if the maturity event at 330 is the tolling of a maturity term or the passing of a specific maturity date. If the maturity event at 330 is the tolling of a term or passing of a specific date, the method continues to 350. If no maturity term or specific maturity date is present in the set of maturity events, or if the maturity event at 330 is not a term or specific date, the method continues to 360.

In one embodiment of the invention, in the event that a maturity term has tolled or a specific maturity date has passed in the investment hedge, the investment hedge system may optionally be frozen at the market foreign exchange rate in effect at the time of the maturity event. In this scenario, a mark-to-market calculation of the value of the investment hedge structure may be conducted, and the hedge value is fixed at that valuation. This mark-to-market calculation is then passed to 380 upon the sale, divestment, or any other exit from the investment by the Financial Sponsor.

At 360, the investment hedge system may determine if the maturity event at 330 is a partial sale or other divestment of part interest in the investment, which could take place as a part of a credit event or restructuring of the investment. If the maturity event at 330 is a partial sale or other divestment of part interest in the investment, the method continues to 370 in order to split the investment hedge. If the maturity event at 330 is not a partial sale or other divestment of part interest in the investment, the method continues to 380.

At 370, the method may recognize that a partial interest in the investment is maintained by the Financial Sponsor, and accordingly may recognize that only a portion of the investment hedge which represents the divested or sold interest in the investment may be hedged at this time. Accordingly, and as in one of the embodiments of the invention, the investment hedge system splits the investment hedge into two parts: a divested investment part and a retained investment part. The divested investment part may then proceed to 380 of the method. The retained investment part may proceed back to 330 and await the occurrence of a maturity event which would apply to that portion of the interest in the investment retained by the Financial Sponsor. In one aspect of the invention, the divested investment part may be calculated to be equal to the percentage of the investment which has been divested by the Financial Sponsor. Accordingly in that aspect, the retained investment part would be equal to the percentage of the investment which has been retained by the Financial Sponsor. In another aspect of the invention, the divested investment part could be equal to the monetary amount of partial divestment proceeds. In this aspect, the investment hedge would be split along the notional value of the hedge such that the retained investment part of the investment hedge would be equal to the remainder of notional after accounting for the monetary divestment proceeds.

At 380, the investment exit module may execute in order to settle or execute the investment hedge. According to one embodiment of the invention, the investment exit module may calculate a return on investment (ROI) on the investment. Typically, this ROI can be calculated by comparing the proceeds from the sale or divestment of the investment with the initial equity investment in the investment. In another aspect of the invention, the ROI can be calculated by comparing the proceeds from the sale or divestment of the investment with the notional value as calculated by the parameter determination module. It will be appreciated by those of ordinary skill that other methods exist of calculating the ROI of an investment.

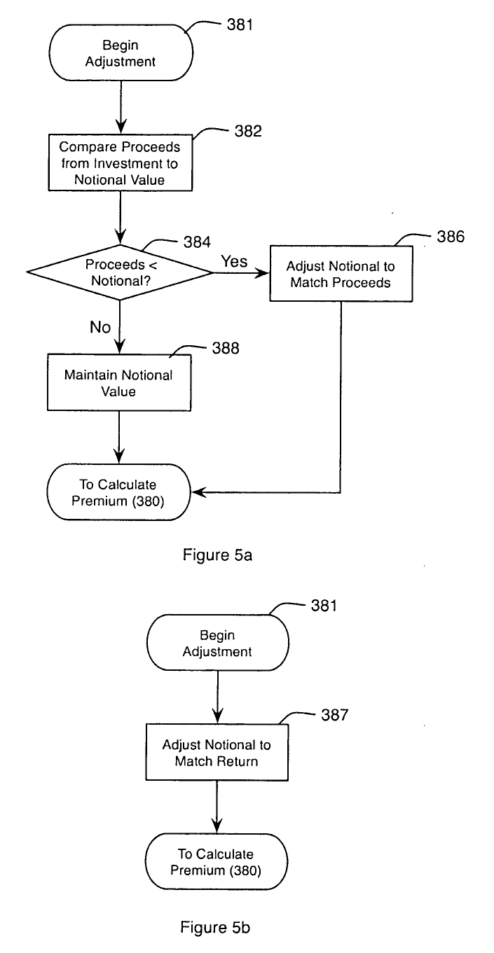

Also at 380, the investment exit module may adjust the notional value that was previously determined at 310. The various methods of adjusting the notional value according to the various embodiments of the invention are now discussed in detail with reference to FIGS. 5a and 5b.

According to one embodiment of the invention, as illustrated in FIG. 5a, following the start of the adjustment process at 381, the investment exit module may compare the proceeds from the investment to the previously determined notional value at 382. At 384, if the proceeds are less than the notional value, the investment exit module may determine that an adjustment of the notional value is ideal. If so, the method moves to 386 for adjustment of the notional value. If an adjustment is not determined to be necessary, the method maintains the value of the previously determined notional value at 388 and continues to use that value in the completion of the investment exit module at 380 of FIG. 3. According to another of the various embodiments, the comparison at 384 could be based upon a percentage of the notional value other than 100%, such as 25%, 50%, 75%, 125%, 150%, 175%, or 200%.

At 386, the investment exit module may have determined that an adjustment of the notional value is ideal. According to one aspect of the invention, the module then adjusts the notional value so that it equals the proceeds from the investment. According to one embodiment of the invention, if there are zero proceeds from the investment (such as in the case of a default), the notional is adjusted to zero. According to other various aspects of the invention, the notional value may be adjusted by a percentage of the difference between the previously determined notional value and the proceeds from the investment, such that the adjusted notional value is between the proceeds value and the previously determined notional value. Upon completion of the adjustment, the method may then use this adjusted notional value in the completion of the investment exit module at 380 of FIG. 3.

According to another embodiment of the invention, as illustrated in FIG. 5b, following the start of the adjustment process at 383, the investment exit module may adjust the notional value so that it equals the proceeds from the investment. According to one embodiment of the invention, there may be no upper or lower limit to the amount of adjustment made to the notional value. According to other various aspects of the invention, the notional value may be adjusted by a percentage of the difference between the previously determined notional value and the proceeds from the investment, such that the adjusted notional value is between the proceeds value and the previously determined notional value. Upon completion of the adjustment, the method may then use this adjusted notional value in the completion of the investment exit module at 380 of FIG. 3.

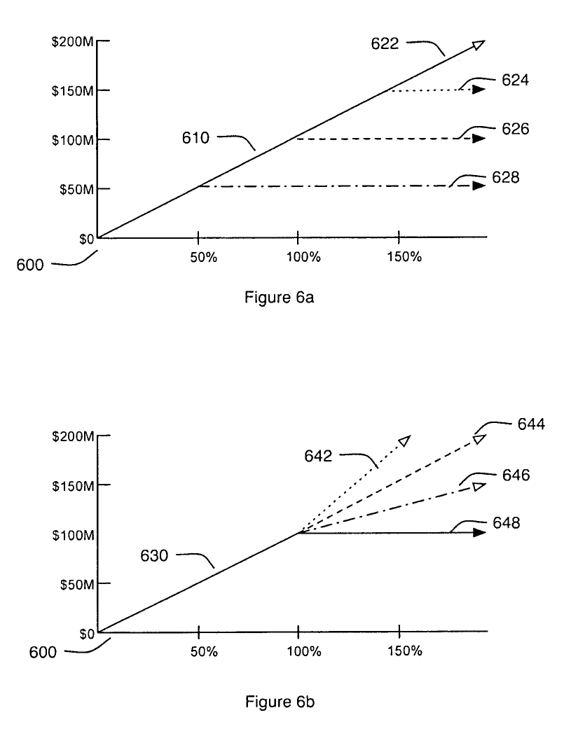

FIG. 6a is illustrative of some of the various embodiments relating to adjusted notional values at described above. Chart 600 shows the proceeds from an investment displayed against the overall return on the investment. Line 610 illustrates a straight-line calculation of proceeds plotted against the percentage return on the investment. Line 622 shows the infinite notional adjustment embodiment as described in FIG. 5b. Line 626 shows the downward notional adjustment embodiment of FIG. 5a. Lines 624 and 628 show possible notional adjustments via comparisons at notional rates other than 100% as described above.

After adjustment, the investment exit module of FIG. 3 may calculate a premium value for the investment hedge. According to one embodiment of the invention, the premium value may be calculated by applying the previously determined premium rate to the proceeds from the sale or divestment of the investment. In this variation, the premium rate applies to the entire return generated from the investment. According to another of the various embodiments, the premium rate may be applied solely to the adjusted notional value such that the rate only covers the amount of investment that was hedged. According to yet another of the various embodiments, the premium rate may be applied to a certain percentage of the overall proceeds, such as 25%, 50%, 75%, 125%, 150%, 175%, or 200%. According to yet another of the various embodiments, the premium rate may be applied to a certain percentage of the adjusted or initial notional values, such as such as 25%, 50%, 75%, 125%, 150%, 175%, or 200%.

As illustrated in FIG. 6b, and in accordance with various embodiments of the invention, the premium rate may also change as it is applied to the proceeds of the investment. In various embodiments, the premium rate may change after the initial notional value has been reached. Chart 600 is exemplary of some of these various embodiments and shows proceeds from an investment displayed against the overall return on the investment. Line 630 shows the straight-line calculation of a premium rate as applied to proceeds as they approach an initial notional of $100M. If the investment proceeds are in excess of the initial notional value of $100M, the premium rate may increase, as in line 642; the premium rate may stay steady, as in line 644; the premium rate may decrease, as in line 646; and the premium rate may turn to zero, as in line 648. As can be seen from the Figure, the change in premium rates has a significant affect on calculated premium values. It will be appreciated by those of ordinary skill that the Figure is exemplary and other variations of the rate may exist.

The investment exit module then may settle or execute the investment hedge at 390. In one of the embodiments of the invention, the investment exit module charges the Financial Sponsor the premium value of the investment hedge. According to one aspect of the invention, the investment exit module then exercises the investment hedge at the previously agreed upon exchange rate and at the adjusted notional value in accordance with any previously selected hedge style as described above.

As an example of some of the various embodiments and aspects of the above detailed investment hedge, the illustrative Blackrock Ltd. may be a Financial Sponsor from the United Kingdom wishing to purchase ABC corporation in the United States as an investment. Blackrock may negotiate a deal with ABC at a price of $100M (U.S. dollars), which would require a capital investment of £55M (pounds) if the exchange rate at the time of the deal is set at 1:0.55 (US$:£). Blackrock does not know how long its investment in ABC will take to be profitable, nor does it know what the exchange rate will be at that time. Without an investment hedge, if the exchange rate upon a possible sale in year four of the investment is set at 1:0.49 (US$:£) because of a weakening of the dollar, a return of the initial $100M investment, if available, will only be worth £49M. If ABC realizes a 90% ROI upon sale in year four ($90M), Blackrock would only realize £44.1M, which would be an actual ROI of about 80% after conversion. Even if ABC realizes a 110% ROI upon sale in year four ($110M), Blackrock would only realize £53.9M at the year four exchange rate of 1:0.49 (US$:£). Consequently, even with a significant ROI on ABC, exchange rate risk can ruin the return for a foreign investor.

Given the same illustrative Blackrock and ABC, Blackrock purchases one of the various embodiments of a CERF product as described above. The notional value may be determined to be equal to the initial $100M (US) investment. The set of maturity events may include a sale of the investment. The premium rate may be set at 6%. The FX rate may be set at the current (year zero) exchange rate of 1:0.55 (US$:£). At the possible year four sale of ABC, if the sale constitutes a 100% ROI of ABC, the notional value may not by adjusted since the proceeds ($100M) are not less than the initial notional value. Accordingly, $100M may be covered by the investment hedge. Blackrock may then realize £55M through the hedge rate at year four (1:0.55 hedge FX rate versus 1:0.49 actual exchange rate) minus the 6% premium rate as may be applied to the adjusted notional ($6M), resulting in proceeds of £51.7M; a full £2.7M greater than the equivalent un-hedged scenario. With a 90% ROI on ABC, the notional value may be adjusted downward to match the proceeds of ABC ($90M), and the principal rate may be applied to this adjusted notional in calculating a principal value. As a result, Blackrock may realize proceeds of £46.53M after payment of principal. This amount is £2.43M greater than the equivalent un-hedged scenario. In a 110% ROI on ABC event, the notional value may be kept at $100M since the proceeds are greater than the initial notional value (although in other embodiments and aspects, the notional value could be adjusted to meet the realized proceeds) and the premium rate may be applied to the proceeds realized (although in other embodiments and aspects, the premium rate may only be applied to the notional value and not the proceeds). The hedged notional of $100M may be converted into £55M and the un-hedged profit of $10M may be converted into £4.9M. A principal value of $6.6M (£3.234M) may be removed from these proceeds. As a result, Blackrock may end this scenario with proceeds of about £56.7M; £2.9M greater than the equivalent un-hedged scenario.

Having described a number of different embodiments of the invention, it should be apparent to the person of ordinary skill that the invention has numerous benefits and advantages. For example, the invention provides a systemized framework for creating variable-notional and variable-maturity investment hedge structures.

The ability for notional values to be adjusted at the end of an investment is beneficial because a Financial Sponsor can hedge against an unknown return without having to purchase excessive and expensive additional hedge.

Further, the ability to have a hedge with a term that is variable allows a Financial Sponsor to purchase the precisely right duration of hedge and allows the Financial Sponsor to concentrate on the appropriate time to exit an investment from a return on investment standpoint instead of in relation to a predefined hedge duration.

The various styles of hedge which are provided through the above mentioned investment hedge further allows Financial Sponsors to accept and limit or take advantage of any amount of foreign exchange risk and rewards which the Financial Sponsor desires.

The invention provides particular benefits to Financial Sponsors that have traditionally avoided foreign-borne investments because of fear of foreign exchange rate exposure. More lucrative investments in more unstable or uncertain currency markets are now encouraged by application of the principles of the invention to these entities which would otherwise not be feasible.

Because the invention allows Financial Sponsors to more efficiently hedge the foreign exchange risk of foreign-borne investments, individuals, businesses, and governments in once underdeveloped and undercapitalized nations will also benefit as more Financial Sponsors from all over the world begin to invest in those nations because the foreign exchange risks associated with those investments are greatly reduced.

Other benefits and advantages of the invention will be apparent to the person of ordinary skill in the art.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

What is claimed is:

1. A computer-implemented method of hedging an investment, comprising:
determining a notional value;
determining one or more maturity events;
creating an investment hedge based upon the notional value and the one or more maturity events; and
adjusting the notional value upon the occurrence of one of the one or more maturity events.

2. The method of claim 1, further comprising
determining a return on the investment; and,
wherein the adjusting the notional value is further based upon the return on the investment.

3. The method of claim 2, further comprising:
determining a premium rate;
calculating a premium; and,
wherein calculating a premium for the investment hedge comprises a calculation based upon the premium rate and the return on the investment.

4. The method of claim 3, wherein the adjusted notional value does not exceed a pre-determined amount.

5. The method of claim 1, further comprising:
determining a premium rate;
calculating a premium; and,
wherein calculating a premium for the investment hedge comprises a calculation based upon the premium rate and the adjusted notional value.

6. The method of claim 5, wherein if the adjusted notional value is zero, the premium for the investment hedge is zero.

7. The method of claim 1, wherein the one or more maturity events comprises at least one of the following: disposal of the investment, partial sale of the investment, credit event at the investment, a refinancing or recapitalization of the investment, a merger of the investment with another corporate entity, the sale or partial sale of subsidiaries of the investment's legal group, a payment of extraordinary dividends or similar distributions by the investment to the Financial Sponsor or its partners, other release of capital from the investment, or other exit from the investment.

8. The method of claim 7, wherein if the maturity event is a partial sale or the sale or partial sale of subsidiaries of the investment's legal group, the method further comprising:
splitting the investment hedge;
calculating a premium; and,
wherein the calculating a premium of the investment hedge is a partial premium calculation based upon the investment sold.

9. The method of claim 7, wherein the one or more maturity events further comprises a maximum term.

10. The method of claim 9, wherein the maximum term is 5 years.

11. The method of claim 9, wherein if the occurrence of one of the one or more maturity events is the maximum term, the method further comprising:
freezing a mark-to-market calculation of the investment hedge upon the maximum term occurrence; and,
wherein the calculating a premium for the investment hedge occurs upon a later sale of the investment and is based upon the mark-to-market calculation and in consideration of prevailing interest rate and credit spreads.

12. The method of claim 1, wherein the investment hedge further comprises at least one additional hedge parameter, said at least one additional hedge parameter determining the risk to be hedged and selected from the group consisting of foreign exchange risk, interest rate risk, credit risk, commodity price risk, weather futures price risk, property derivative risk, and longevity risk.

13. The method of claim 1, wherein the investment hedge is a Contingent Equity Return Forward.

14. The method of claim 1, wherein the investment hedge is a Contingent Equity Return Option.

15. A system for hedging an investment, comprising:
a processor reading executable code written to instruct the processor to:
determine a notional value;
determine one or more maturity events;
create an investment hedge based upon the notional value and the one or more maturity events;
adjust the notional value upon the occurrence of one of the one or more maturity events; and,
calculate a premium for the investment hedge.

16. A computer-implemented system for hedging an investment, comprising:
a Parameter Determination Module for determining a notional value, one or more maturity events, and at least one additional hedge parameter;
a Hedge Creation Module for creating an investment hedge using the notional value, the one or more maturity events, and the at least one additional hedge parameter; and,
an Investment Exit Module for adjusting the notional value and calculating a premium for the investment hedge; and,
wherein the Investment Exit Module executes upon the occurrence of one of the one or more maturity events.

17. The system of claim 16, wherein the at least one additional hedge parameter is selected from the group consisting of foreign exchange risk, interest rate risk, credit risk, commodity price risk, weather futures price risk, property derivative risk, and longevity risk.

18. The system of claim 16, wherein the one or more maturity events comprises at least one of the following: disposal of the investment, partial sale of the investment, credit event at the investment, a refinancing or recapitalization of the investment, a merger of the investment with another corporate entity, the sale or partial sale of subsidiaries of the investment's legal group, a payment of extraordinary dividends or similar distributions by the investment to the Financial Sponsor or its partners, other release of capital from the investment, or other exit from the investment.

19. The system of claim 18, wherein if the maturity event is a partial sale, the Investment Exit Module further calculates a percentage of the investment sold and splits the investment hedge into a sold portion and an unsold portion based on the percentage of the investment sold; and,
wherein the Investment Exit Module adjusts and calculates based upon the sold portion of the investment hedge.

20. The system of claim 16, wherein the Investment Exit Module further determines a return on the investment and adjusts the notional value based on the return on the investment.

21. The system of claim 20, wherein the at least one additional parameter comprises a premium rate, and wherein the Investment Exit Module calculates the premium for the investment hedge based on the premium rate and the return on the investment.

22. The system of claim 16, wherein the at least one additional parameter comprises a premium rate, and wherein the Investment Exit Module calculates the premium for the investment hedge based on the premium rate and the adjusted notional value.

23. The system of claim 16, wherein the one or more maturity events comprises a maximum term.

24. The system of claim 23, wherein if the occurrence of one of the one or more maturity events is the maximum term, the Investment Exit Module further freezes a mark-to-market calculation of the investment hedge upon the maximum term occurrence, and, wherein the Investment Exit Module calculates the premium for the investment hedge upon a later sale of the investment and is based upon the mark-to-market calculation.

25. A system for hedging an investment, comprising:
a Financial Sponsor in a first market having a first currency;
an investment in a second market having a second currency;
an exchange rate between the first currency and the second currency;
an exchange rate investment hedge, comprising,
a notional value,
a plurality of maturity events,
a premium rate, and
a premium value;
wherein the Financial Sponsor purchases the investment in the second currency;
further wherein the exchange rate fluctuates;
further wherein the Financial Sponsor enters into the investment hedge in order to mitigate said exchange rate fluctuations;
further wherein, at the occurrence of one of the plurality of maturity events, the exchange rate investment hedge:
if a return on the investment is less than the notional value, adjusts the notional value downward to correspond with a percentage return on the investment,
calculates the premium value based upon the return on the investment and the premium rate, and
charges the Financial Sponsor the premium value.
